(19) United States
(12) Patent Application Publication
(10) Pub. No.: US 2024/0152503 A1
(43) Pub. Date: May 9, 2024

(54) APPARATUS AND METHOD FOR SEARCHING FOR ON-CHAIN DATA BASED ON INDEX

(71) Applicant: ELECTRONICS AND TELECOMMUNICATIONS RESEARCH INSTITUTE, Daejeon (KR)

(72) Inventors: Ji-Yong KIM, Daejeon (KR); Mi-Young JANG, Daejeon (KR); Jong-Ho WON, Daejeon (KR)

(73) Assignee: ELECTRONICS AND TELECOMMUNICATIONS RESEARCH INSTITUTE, Daejeon (KR)

(21) Appl. No.: 18/326,673

(22) Filed: May 31, 2023

(30) Foreign Application Priority Data
Nov. 3, 2022 (KR) 10-2022-0145535

(51) Int. Cl. G06F 16/23; G06F 16/22

(52) U.S. Cl. CPC G06F 16/2379; G06F 16/2246

(57) ABSTRACT

Disclosed herein are an apparatus and method for retrieving on-chain data based on an index. The apparatus includes memory in which at least one program is recorded and a processor for executing the program. The program may include a blockchain connection manager for recording data in at least one node or retrieving data from at least one node and outputting the same by being connected to a blockchain network formed of multiple nodes, a blockchain index manager for creating and managing an index for data stored in at least one node, and a query engine for requesting storage of data resulting from a transaction in a corresponding node through the blockchain connection manager, creating an index on the stored data by interworking with the blockchain index manager, and acquiring and outputting data that is retrieved based on the index through the blockchain connection manger in response to a retrieval request.

### CROSS REFERENCE TO RELATED APPLICATION

This application claims the benefit of Korean Patent Application No. 10-2022-0145535, filed Nov. 3, 2022, which is hereby incorporated by reference in its entirety into this application.

### BACKGROUND OF THE INVENTION

### 1. Technical Field

The disclosed embodiment provides technology for quickly retrieving transaction data using various indices in a blockchain platform environment.

### 2. Description of the Related Art

When data is stored through a blockchain, a reliable data platform may be formed thanks to characteristics such as consensus, repeated storage of data, and prevention of deletion or modification of data. However, retrieving data satisfying a desired condition from a ledger requires a procedure of sequentially checking whether data matches the desired condition by reading the ledger from the beginning.

In order to remedy such an inefficient sequential access method, data retrieval of a blockchain platform may be configured such that a state DB or a history DB provided in the platform is constructed so as to improve search efficiency or such that a search service is provided by copying blockchain data to an external off-chain DB.

When a method provided in the platform is used, retrieval may be performed using only a designated key value, and retrieving data using other conditions or attributes requires sequentially reading the blocks of the blockchain platform from the beginning and comparing the same, which lowers efficiency. Further, due to limitations of key values and index structures used in an existing state DB or history DB, improvement in search efficiency may be limited.

Also, when a data search service is provided by copying blockchain data to an external DB, it is not easy to maintain synchronization with data of the blockchain platform, and data inconsistency may result in an error. Further, recording values outside the blockchain (off-chain) has a risk of breaking reliability due to data modification.

### SUMMARY OF THE INVENTION

An object of the disclosed embodiment is to improve data search efficiency using various indices in a blockchain platform environment.

Another object of the disclosed embodiment is to improve search efficiency by directly retrieving data from a blockchain node and providing the same and by forming various indices depending on the characteristics of data.

An apparatus for searching for on-chain data based on an index according to an embodiment includes include a blockchain connection manager for recording data in at least one node of a blockchain network or retrieving data from at least one node of the blockchain network and outputting the same by being connected to the blockchain network formed of multiple nodes connected with each other, a blockchain index manager for creating and managing at least one index corresponding to data stored in at least one node of the blockchain network, and a query engine for processing a data storage request or a data search request received from an outside based on the index by interworking with the blockchain connection manager and the blockchain index manager.

Here, the blockchain index manager may include at least one of an event index module, a content-based index module, a time-series index module, a spatial index module, or a key index module, or a combination thereof.

Here, the query engine may include an index definition unit for defining a data schema corresponding to data to be stored before the data is stored in at least one node of the blockchain network, setting a key or condition to be created as an index, and selecting an index structure depending on characteristics of the data to be stored.

Here, the index structure may be selected from among structures including a binary tree, an R-tree, a k-dimensional (k-d) tree, a B-tree, and a B+ tree.

Here, the query engine may further include a data storage processing unit for making a request to store data resulting from occurrence of a transaction in a corresponding node based on the defined data schema through the blockchain connection manager and recording a key or condition to be created as an index on the stored data and a transaction number in at least one corresponding index.

Here, when an index is constructed for already stored transactions, the data storage processing unit may acquire all data stored in at least one node of the blockchain network through the blockchain connection manager, check column information corresponding to a key or condition to be created as an index in the acquired data, and transfer a key or condition to be created as an index and a transaction number, among data satisfying a predefined key or condition, to the blockchain index manager.

Here, the data storage processing unit may transfer a second index key, which is acquired by converting a first index key that is a target to be indexed using a user-specified function, to the blockchain index manager along with a transaction number corresponding thereto.

Here, the query engine may further include a data search processing unit for acquiring a transaction number from the index using a predetermined key or condition through the blockchain index manager and acquiring data corresponding to the acquired transaction number through the blockchain connection manager in response to a request to retrieve the data corresponding to the predetermined key or condition.

A method for searching for on-chain data based on an index according to an embodiment may include storing data resulting from occurrence of a transaction in at least one node of a blockchain network and creating an index for the stored data; and retrieving data based on the index and outputting the data in response to a request to retrieve the data.

Here, the index may include at least one of an event index, a content-based index, a time-series index, a spatial index, or a key index, or a combination thereof.

The method may further include, before storing the data in the at least one node of the blockchain network, defining a data schema corresponding to the data to be stored, setting a key or condition to be created as an index, and selecting an index structure depending on characteristics of the data to be stored.

Here, the index structure may be selected from among structures including a binary tree, an R-tree, a k-d tree, a B-tree, and a B+ tree.

Here, creating the index may include storing the data resulting from the occurrence of the transaction in the node of the blockchain network based on the defined data schema and recording a key or condition to be created as an index on the stored data and a transaction number in at least one corresponding index.

Here, creating the index may comprise, when the index is constructed for already stored transactions, acquiring all data stored in at least one node of the blockchain network, checking column information corresponding to a key or condition to be created as an index in the acquired data, and inserting a key or condition to be created as an index and a transaction number, among data satisfying a predefined key or condition, into the index.

Here, creating the index may comprise inserting a second index key, which is acquired by converting a first index key that is a target to be indexed using a user-specified function, into the index along with a transaction number corresponding thereto.

Here, retrieving and outputting the data may comprise acquiring a transaction number from the index using a predetermined key or condition and acquiring the data corresponding to the acquired transaction number from the blockchain network in response to a request to retrieve the data corresponding to the predetermined key or condition.

A method for searching for on-chain data based on an index, performed by a query engine interworking with a blockchain connection manager, which is connected with a blockchain network formed of multiple nodes connected with each other and is configured to record data in at least one node or retrieve data from at least one node and output the same, and a blockchain index manager, which is configured to create and manage an index corresponding to data stored in at least one node of the blockchain network, according to an embodiment may include defining a data schema corresponding to data to be stored before the data is stored in at least one node of the blockchain network, setting a key or condition to be created as an index, and selecting an index structure depending on characteristics of the data to be stored; making a request to store data resulting from occurrence of a transaction in a corresponding node based on the defined data schema through the blockchain connection manager and recording a key or condition to be created as an index on the stored data and a transaction number in at least one corresponding index; and acquiring a transaction number from the index using a predetermined key or condition through the blockchain index manager, acquiring data corresponding to the acquired transaction number through the blockchain connection manager, and outputting the data in response to a request to retrieve the data corresponding to the predetermined key or condition.

Here, the index may include at least one of an event index, a content-based index, a time-series index, a spatial index, or a key index, or a combination thereof, and the index structure may be selected from among structures including a binary tree, an R-tree, a k-d tree, a B-tree, and a B+ tree.

Here, recording the key or condition and the transaction number may comprise, when the index is constructed for already stored transactions, acquiring all data stored in at least one node of the blockchain network through the blockchain connection manager, checking column information corresponding to a key or condition to be created as an index in the acquired data, and transferring a key or condition to be created as an index and a transaction number, among data satisfying a predefined key or condition, to the blockchain index manager.

Here, recording the key or condition and the transaction number may comprise transferring a second index key, which is acquired by converting a first index key that is a target to be indexed using a user-specified function, to the blockchain index manager along with a transaction number corresponding thereto.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of a system including an apparatus for searching for on-chain data based on an index according to an embodiment;

FIG. 2 is a block diagram of a query engine according to an embodiment;

FIG. 3 is an example of pseudo code of an index structure definition step according to an embodiment;

FIG. 4 is an example of data corresponding to a vehicle tachograph called DTG;

FIG. 5 is an example of pseudo code of a data storage step according to an embodiment;

FIG. 6 is an example of pseudo code of a data search step according to an embodiment;

FIG. 7 and FIG. 8 are signal flowcharts for explaining a method for searching for on-chain data based on an event index according to an embodiment;

FIG. 9 is an exemplary view of DTG data;

FIG. 10 is an exemplary view of construction of an event index for the speed column illustrated in FIG. 9;

FIG. 11 is an exemplary view of a time-series index structure according to an embodiment; and

FIG. 12 is a view illustrating a computer system configuration according to an embodiment.

### DESCRIPTION OF THE PREFERRED EMBODIMENTS

The advantages and features of the present disclosure and methods of achieving the same will be apparent from the exemplary embodiments to be described below in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only, and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

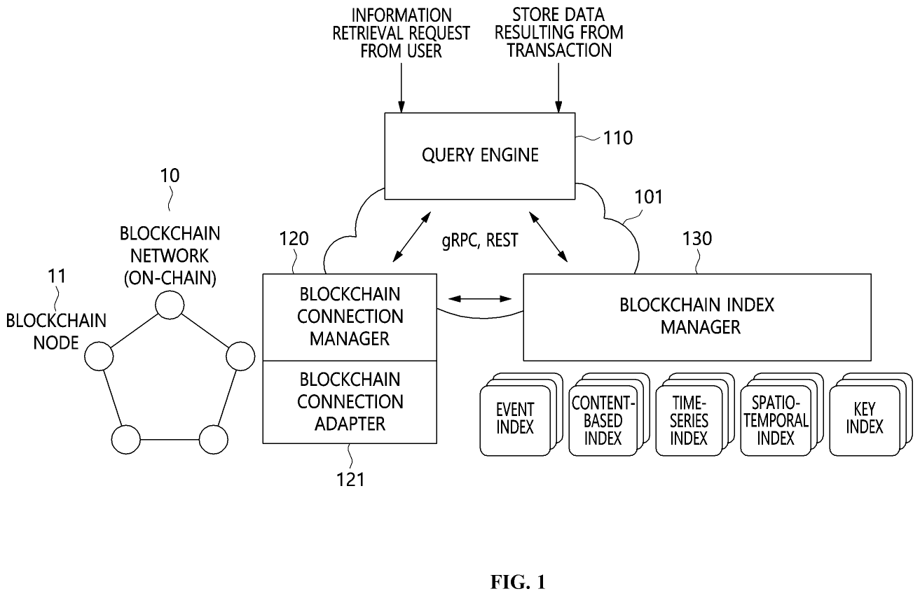

Hereinafter, an apparatus and method for searching for on-chain data based on an index according to an embodiment will be described in detail with reference to FIGS. 1 to 12.

FIG. 1 is a schematic block diagram of a system including an apparatus for searching for on-chain data based on an index according to an embodiment.

Referring to FIG. 1, the apparatus for searching for on-chain data based on an index according to an embodiment interworks with a blockchain network 10 formed by connecting multiple blockchain nodes 11, thereby storing and searching for blockchain data.

Specifically, the apparatus 100 for searching for on-chain data based on an index may include a query engine 110, a blockchain connection manager 120, and a blockchain index manager 130.

However, this is merely an embodiment, and the query engine 110, the blockchain connection manager 120, and the blockchain index manager 130 may be physically separate hardware devices and may interwork with each other through wired or wireless communication.

The blockchain connection manager 120 is connected with the blockchain network 10, and may record data in at least one node or retrieve data from at least one node and output the same.

Here, the blockchain connection manager 120 may be connected with various types of blockchain platforms through a blockchain connection adapter 121.

The blockchain index manager 130 may create and manage at least one index corresponding to data stored in at least one node of the blockchain network.

Here, the blockchain index manager 130 may manage various indices in a modularized manner. For example, referring to FIG. 1, the blockchain index manager 130 may manage various index modules including an event index module, a content-based index module, a time-series index module, a spatiotemporal index module, and a key index module.

However, this is merely an embodiment, and the index of the present disclosure may further include various other indices. Also, an index having the same structure may be implemented in various forms depending on a key.

The query engine 110 may process a request to store data or a request to retrieve information, which is received from the outside such as a user or a frontend system, based on the index by interworking with the blockchain connection manager 120 and the blockchain index manager 130.

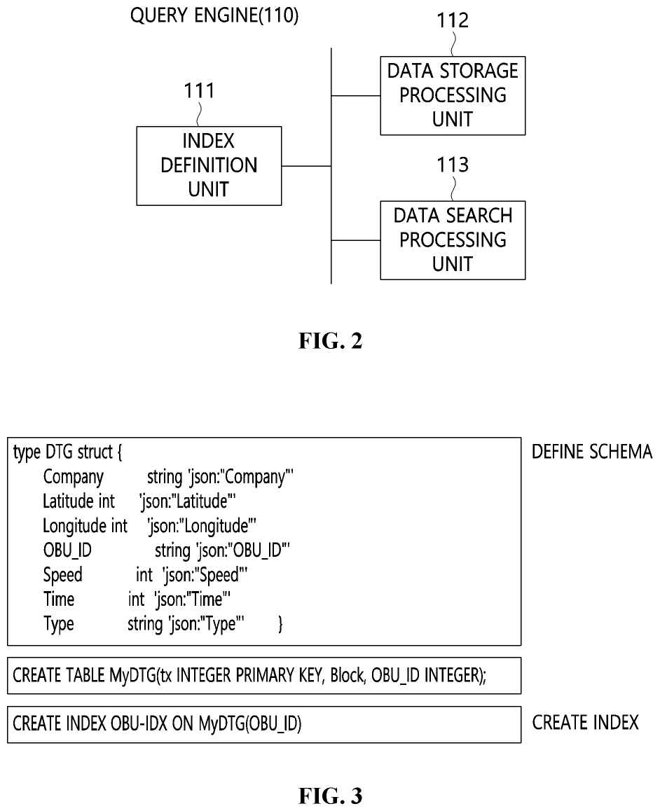

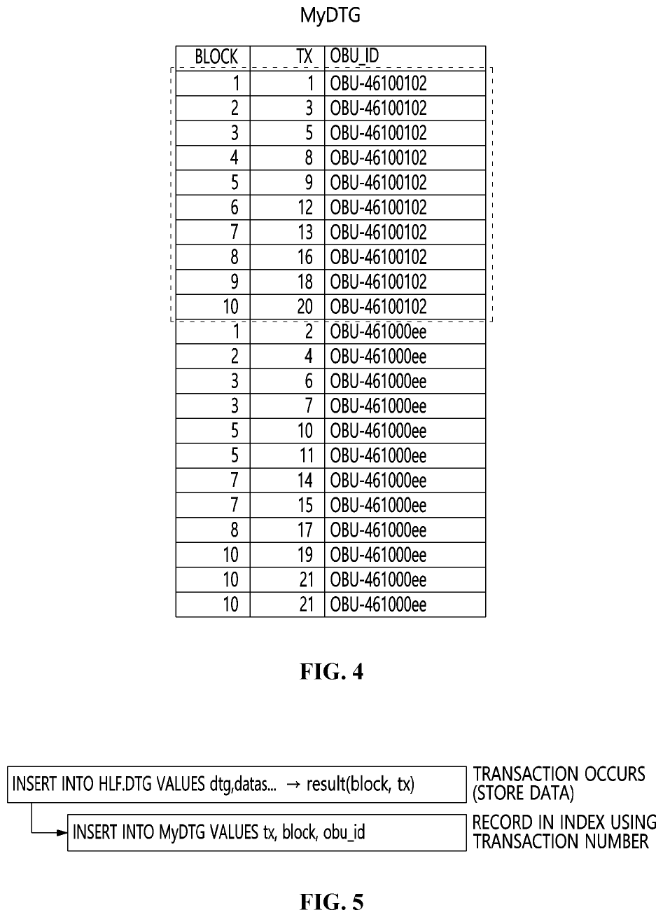

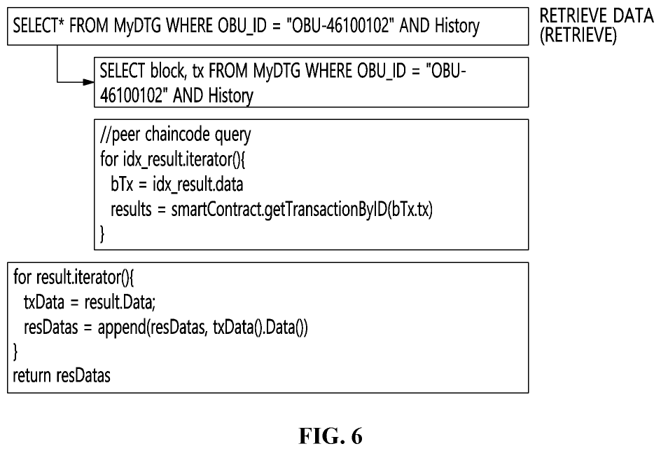

FIG. 2 is a block diagram of a query engine according to an embodiment, FIG. 3 is an exemplary view of pseudo code of an index structure definition step according to an embodiment, FIG. 4 is an exemplary view of data corresponding to a vehicle tachograph called DTG, FIG. 5 is an exemplary view of pseudo code of a data storage step according to an embodiment, and FIG. 6 is an exemplary view of pseudo code of a data search step according to an embodiment.

Referring to FIG. 2, the query engine 110 according to an embodiment may include an index definition unit 111, a data storage processing unit 112, and a data search processing unit 113.

The index definition unit 111 performs advance preparation work for storing or retrieving data based on an index before first data (a genesis block) is stored in at least one node of the blockchain network 10.

First, the index definition unit 111 defines a data schema in consideration of data to be stored. For example, DTG data corresponding to a vehicle tachograph may include a vehicle manufacturer (Company), a latitude and a longitude corresponding to the location of a vehicle, OBU_ID replacing a vehicle number (key), and the like, as illustrated in FIG. 3. Subsequently, a data structure called MyDTG such as that illustrated in FIG. 4 is prepared through the ‘CREATE TABLE’ command in order to define and store data in a table structure corresponding to the data schema definition.

Subsequently, the index definition unit 111 sets a key or condition to be created as an index. For example, OBU_ID may be set as an index key, as shown in FIG. 3.

Also, the index definition unit 111 may select and set an index structure efficient for retrieval depending on the index type. For example, a multi-dimensional index structure may be selected for a content-based index, a multi-level index structure may be selected for a time-series index, and an R-tree index structure may be selected for a spatiotemporal index.

When a transaction occurs with the start of a domain service, the data storage processing unit 112 may process data resulting from the transaction so as to be stored in a corresponding node based on the predefined data schema through the blockchain connection manager 120. For example, referring to FIG. 5, data may be recorded through the ‘INSERT INTO’ command when a transaction occurs.

Subsequently, the data storage processing unit 112 records a key or condition to be created as an index on the stored data and a transaction number in a predefined index through the blockchain index manager 130. For example, referring to FIG. 5, the transaction number is recorded in the index.

Here, the data storage processing unit 112 selects a suitable index from among various types of indices depending on the characteristics of data and requests the blockchain index manager 130 to record the data in the selected index. Also, when a transaction (storage of data) occurs, it may be simultaneously recorded in multiple types of indices depending on the initial index definition.

In response to a request to retrieve data corresponding to a predetermined key or condition, the data search processing unit 113 acquires a transaction number from the index using the predetermined key or condition through the blockchain index manager 130 and acquires data corresponding to the acquired transaction number through the blockchain connection manager 120.

Here, a user requests retrieval using a key or condition of the data to retrieve, in which case the user does not know the existence of the index. The data search processing unit 113 may understand the content of the retrieval request of the user, determine whether the blockchain index can be used, and acquire a transaction number using the key or condition of the request through the blockchain index manager 130 when it determines that the index can be used.

Subsequently, the data search processing unit 113 acquires data corresponding to the acquired transaction number from a blockchain node 11 of the blockchain network 10 through the blockchain connection manger 120.

Here, the transaction number matching the key or condition of the request in the index may be a set of transaction numbers, and generally, data corresponding to the set of transaction numbers may also be multiple pieces of data.

For example, when the data search processing unit 113 sets the key (OBU_ID) to ‘OBU-46100102’ and requests retrieval of data from the blockchain network 10 through the blockchain connection manager 120, as illustrated in FIG. 6, the blockchain network 10 may return a list of transaction numbers boxed with the dotted line in the MyDTG table illustrated FIG. 4, which are the retrieved data corresponding to the key in the MyDTG table.

Meanwhile, the embodiment may be implemented as chain code in Hyperledger Fabric, but may be implemented in the form of a smart contract if the blockchain platform is in the Ethereum environment. That is, the embodiment may be implemented in different forms depending on the type of the blockchain platform environment.

Also, the index definition unit 111 may operate only once at first. In contrast, the data storage processing unit 112 and the data search processing unit 113 may repeatedly operate whenever a request to store data and a request to retrieve data are received, and may operate simultaneously.

When a data service is provided as described above, a new index may be added using a method of sequentially reading data from a genesis block to the newest block and recording an index. Adding an index in this way may have low efficiency, but there is no need to interrupt the data service that is being provided.

The efficiency of retrieval may be improved by providing various types of indies according to an embodiment. That is, the optimum query plan is made depending on a result of analysis of a user query by the query engine 110, and an index is used through the blockchain index manager 130, whereby the best search performance is ensured.

Hereinafter, a method for searching for on-chain data based on an index according to an embodiment will be described in detail using an example of an event index and a time-series index.

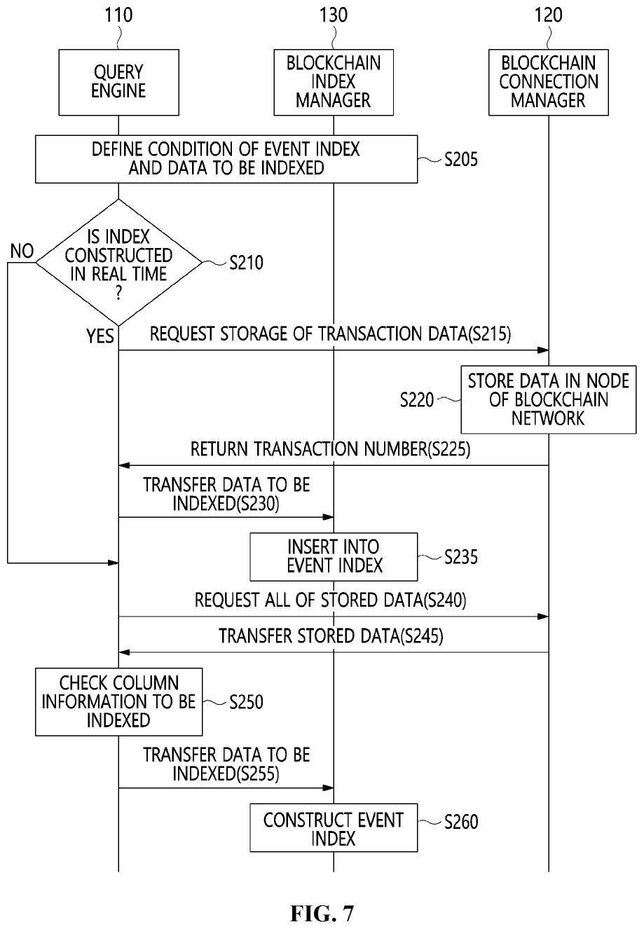

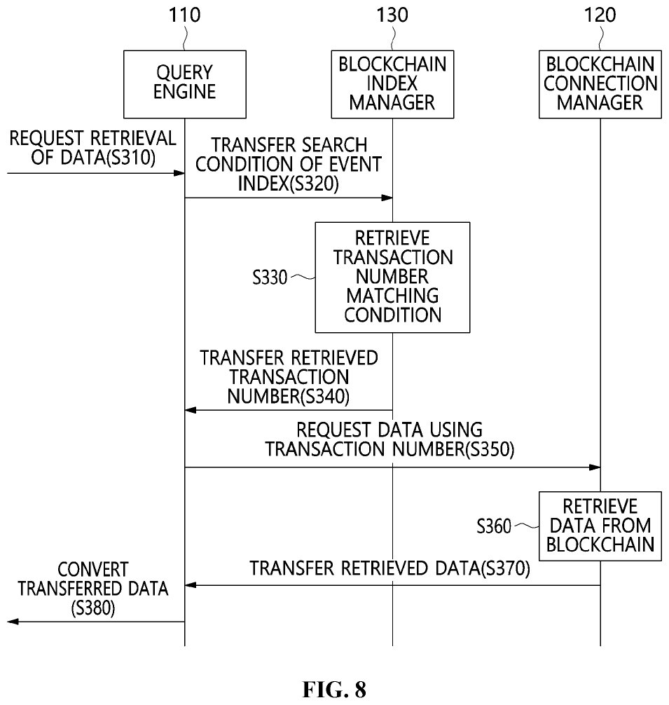

FIG. 7 and FIG. 8 are signal flowcharts for explaining a method for searching for on-chain data based on an event index according to an embodiment.

The event index may be formed when a predefined specific event occurs. The query engine 110 may construct an index when data is first stored, or may construct an index on data already stored in the blockchain network 10.

Referring to FIG. 7, when a condition for constructing an event index is set, the query engine 110 and the blockchain index manager 130 may share the same and define data to be indexed at step S205. Here, the query engine 110 initializes a structure for defining the event index and determines the target to be indexed by specifying an event condition.

Subsequently, when it is determined at step S210 that an index is constructed in real time, the query engine 110 requests the blockchain connection manager 120 to store transaction data at step S215.

In response thereto, the blockchain connection manager 120 stores the transaction data in a node of the blockchain network 10 at step S220 and transfers a transaction number returned by the blockchain network 10 to the query engine 110 at step S225.

Using the transaction number, the query engine 110 generates a pair comprising <index value, (data key, transaction number)> of the data to be indexed and transfers the same to the blockchain index manager 130 at step S230. Accordingly, the blockchain index manager 130 inserts the corresponding information into the event index at step S235.

Meanwhile, when it is determined at step S210 that an index is constructed for already stored transactions, rather than constructing an index in real time, the query engine 110 request all data stored in the blockchain platform through the blockchain connection manager 120 at step S240 and acquires the same at step S245. Subsequently, the query engine 110 checks column information to be indexed at step S250 while sequentially reading the transaction data, and transfers a pair comprising <index value, (data key, transaction number)> of the data satisfying a condition to the blockchain index manager 130 at step S255, thereby constructing an index at step S260.

Here, the data key may not be an essential component. This is included in the example because a specific blockchain platform may request the data key as an argument of an API for a data search. However, because each transaction can be identified using a transaction number, the index value may be implemented using only the transaction number depending on the circumstances.

Also, a binary tree, an R-tree for a multi-dimensional spatial data index, a k-dimensional (k-d) tree, a B-tree for supporting a quick search for sorted data, a B+ tree, or the like may be used for the index schema depending on the characteristics of the stored data. Here, the event index may store multiple pieces of data in a single node, and may be formed using a B-tree that supports a quick search because it is a balanced tree.

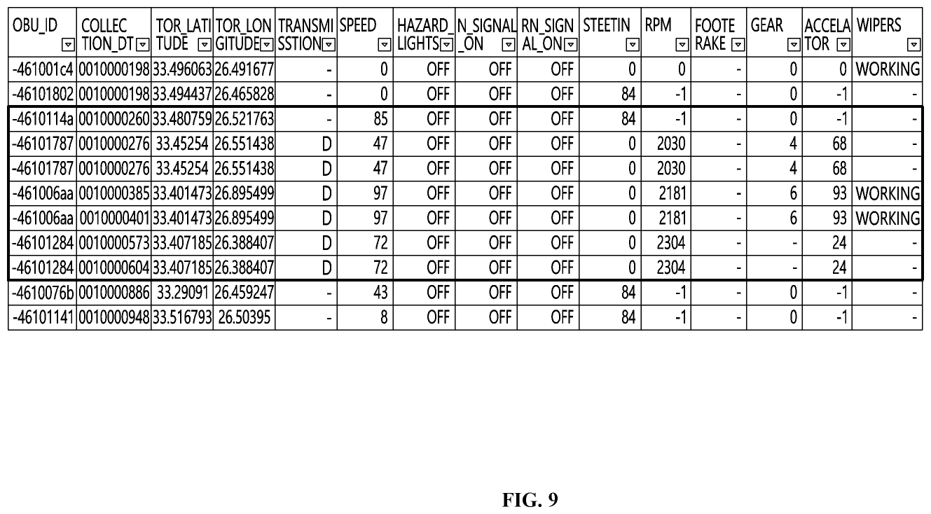

An example of forming a key index (a B-tree index) for data satisfying an event condition, among the above-described DTG data, will be described with reference to FIG. 8 and FIG. 9.

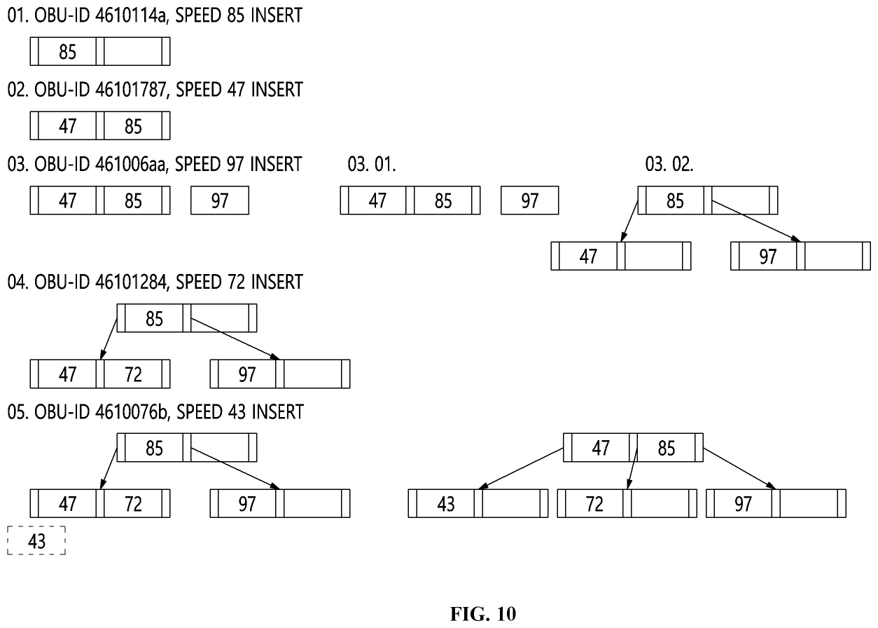

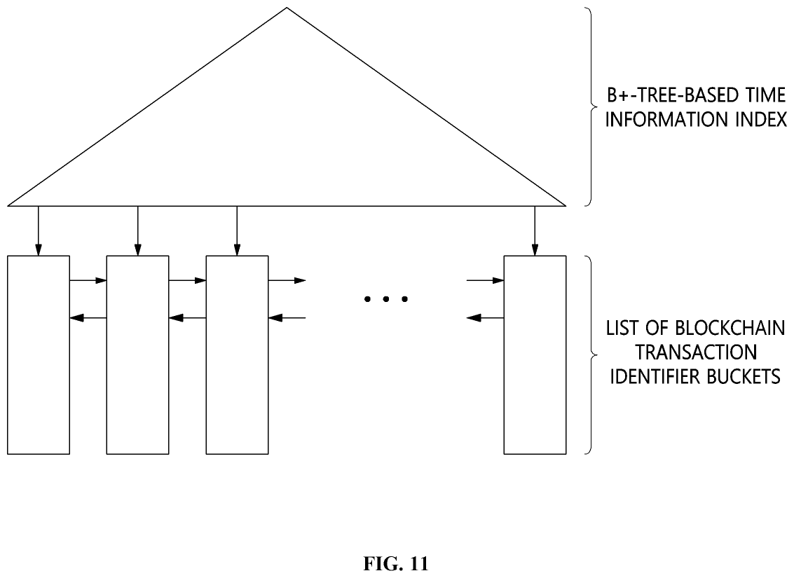

FIG. 9 is an exemplary view of DTG data, and FIG. 10 is an exemplary view of construction of an event index for the speed column illustrated in FIG. 9.

When an event index is assumed to index data satisfying the condition of a speed value equal to or greater than 30 for the SPEED column illustrated in FIG. 9, five speed values, which are 85, 47, 97, 72, and 43, satisfy the condition, excluding the repeated values. In the event index, the speed value of each transaction is set as an index key value, and a transaction number is stored for each key.

When the data to be indexed is selected, a data structure is changed by taking the data value of the corresponding column as a key value, and data is inserted into the index, as illustrated in FIG. 10.

Using the event index finally constructed as shown in FIG. 9, data satisfying the desired speed condition may be quickly retrieved.

Here, when the original speed value of each transaction is used as an index key according to another embodiment, the data stored in the blockchain may be leaked, so the original index key may be converted through a previously agreed user-specified function before being indexed.

With regard to this, an example in which a traffic management application service is configured using DTG data and a vehicle suspected of a hit-and-run in a school zone is searched for in response to a request from a traffic police will be described below.

Referring to FIG. 8, a query engine 110 according to an embodiment may perform an effective search in a blockchain platform based on a spatiotemporal index and an event index using information such as the speed of a vehicle (e.g., speed>70), and the time and location thereof in response to a request to search for a vehicle suspected of a hit-and-run at step S310.

First, data corresponding to the accident date and the travel radius of a suspected vehicle is retrieved based on the spatiotemporal index. Because it is known that a getaway vehicle drives fast at speeds equal to or greater than 70, the condition (event) of a speeding vehicle (speed>30) stored in the event index is satisfied.

Accordingly, the query engine 110 transfers the search condition ‘SPEED>70’ to the blockchain index manager 130 at step S320. Then, at step S340, the query engine 110 may acquire OBU-ID and the transaction number of data matching the condition, which is retrieved by the blockchain index manager 130 at step S330.

Subsequently, the query engine 110 combines the results of retrieval using the spatiotemporal index and the event index, searches DTG data containing the travel record of the final candidate for the suspected vehicle, retrieves a pair of the transaction number and OBU_ID (vehicle number (key)) of the corresponding data, requests actual data from the blockchain connection manager 120 at step S350, receives the data, which is retrieved by the blockchain connection manager 120 at step S360, at step S370, and returns the same to a user at step S380.

Also, the query engine 110 may construct a time-series index on data that is first stored or data already stored in a blockchain network.

When a condition for constructing a time-series index is set, the query engine and the index manager share the condition and define data to be indexed. Subsequently, a structure defining the time-series index is initialized.

When an index is constructed for data that is first stored, after a transaction is generated, a transaction number is returned by a blockchain platform, and the query engine detects this and transfers a pair comprising <index time value, transaction number> of the data to be indexed to the index manager. The blockchain index manager 130 inserts the corresponding information into the time-series index.

When an index is constructed for already stored transactions, the query engine requests all data stored in a blockchain platform through the blockchain connection manager. Then, the query engine sequentially reads the transaction data, checks time information to be indexed, and transfers a pair comprising <index time value, transaction number> of the data satisfying a condition to the index manager, thereby constructing the index.

FIG. 11 is an exemplary view of a time-series index structure according to an embodiment.

Referring to FIG. 11, the time-series index may have a two-level index structure configured with a B+-tree-based time information index and a list of transaction identifier buckets, each having blockchain transaction identifiers corresponding to the same time, by reflecting the characteristics of time-series data to be indexed.

The B+-tree-based time information index is configured such that internal nodes thereof form a B+ tree index in which a time value is set as an index key and each leaf node thereof points to a blockchain transaction identifier bucket containing transaction identifier information having the same time value, and the list of blockchain transaction identifier buckets is constructed as a unidirectional (or bidirectional) linked list.

Using the time-series index having the two-level index structure, the transaction identifier information corresponding to a single time point may be quickly retrieved using the blockchain transaction identifier bucket pointed to by a leaf node of the B+ tree, and transaction identifier information for a certain time range may be quickly retrieved by traversing the linked list of blockchain transaction identifier buckets from the blockchain transaction identifier bucket corresponding to the start time of the time range.

When a user retrieves time-series data, a query engine makes and executes a query plan after determining whether a time-series index is present. Here, the procedure is similar to the procedure of the above-described event index, and thus a description thereof will be omitted.

Here, two embodiments for an event index and a time-series index are described, but the present disclosure may support various other indices by adding the same as modules. Here, because a query engine understands the configuration and content of predefined various indices and makes and executes a query plan, a fast data search may be realized.

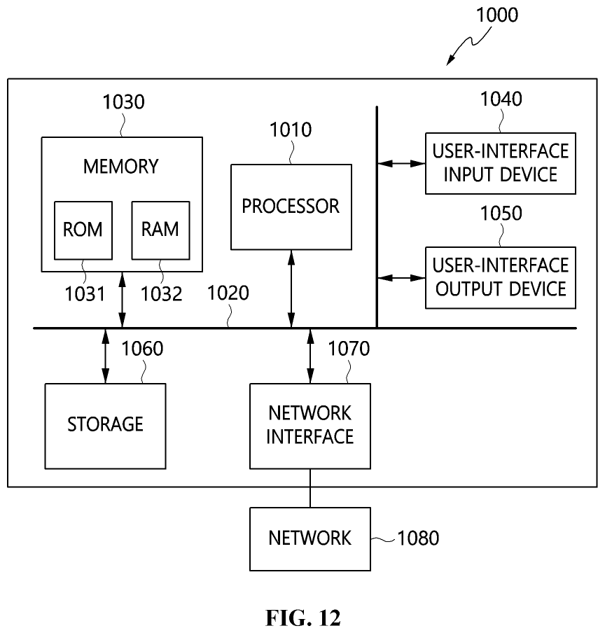

FIG. 12 is a view illustrating a computer system configuration according to an embodiment.

Each of the apparatus for searching for on-chain data based on an index, the query engine 110, the blockchain connection manager 120, and the blockchain index manager 130 according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

Also, the program may perform the following method for searching for on-chain data based on an index.

The method for searching for on-chain data based on an index according to an embodiment includes defining a data schema corresponding to data to be stored before the data is stored in at least one node of a blockchain network and setting a key or condition to be created as an index, and may further include selecting an index structure depending on the characteristics of the data to be stored.

Here, the index structure may be selected from among structures including a binary tree, an R-tree, a k-d tree, a B-tree, and a B+ tree.

Here, creating an index may include storing data resulting from occurrence of a transaction in a node of the blockchain network based on the defined data schema and recording the key or condition to be created as an index on the stored data and a transaction number in at least one corresponding index.

Here, creating the index may comprise, when the index is constructed for already stored transactions, acquiring all data stored in at least one node of the blockchain network, checking column information corresponding to a key or condition to be created as an index in the acquired data, and inserting the key or condition to be created as an index and a transaction number, among the data satisfying a predefined key or condition, into the index.

Here, creating the index may comprise inserting a second index key, which is acquired by converting a first index key to be indexed using a user-specified function, into the index along with the transaction number corresponding thereto.

Here, retrieving and outputting data comprises acquiring a transaction number from the index using a predetermined key or condition and acquiring data corresponding to the acquired transaction number from the blockchain network in response to a request to retrieve the data corresponding to the predetermined key or condition.

According to the disclosed embodiment, search efficiency may be improved by forming various indices for a data search. Also, because data is not maintained outside a blockchain platform, an additional task for synchronization is not required and errors attributable to data inconsistency may be prevented.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for searching for on-chain data based on an index, comprising:
a blockchain connection manager for recording data in at least one node of a blockchain network or retrieving data from at least one node of the blockchain network and outputting the data by being connected to the blockchain network formed of multiple nodes connected with each other,
a blockchain index manager for creating and managing at least one index corresponding to data stored in at least one node of the blockchain network, and
a query engine for processing a data storage request or a data search request received from an outside based on the index by interworking with the blockchain connection manager and the blockchain index manager.

2. The apparatus of claim 1, wherein the blockchain index manager includes at least one of an event index module, a content-based index module, a time-series index module, a spatial index module, or a key index module, or a combination thereof.

3. The apparatus of claim 1, wherein the query engine includes an index definition unit for defining a data schema corresponding to data to be stored before the data is stored in at least one node of the blockchain network, setting a key or a condition to be created as an index, and selecting an index structure depending on characteristics of the data to be stored.

4. The apparatus of claim 3, wherein the index structure is selected from among structures including a binary tree, an R-tree, a k-dimensional (k-d) tree, a B-tree, and a B+ tree.

5. The apparatus of claim 3, wherein the query engine further includes a data storage processing unit for making a request to store data resulting from occurrence of a transaction in a corresponding node based on the defined data schema through the blockchain connection manager and recording a key or condition to be created as an index on the stored data and a transaction number in at least one corresponding index.

6. The apparatus of claim 5, wherein, when an index is constructed for already stored transactions, the data storage processing unit acquires all data stored in at least one node of the blockchain network through the blockchain connection manager, checks column information corresponding to a key or condition to be created as an index in the acquired data, and transfers a key or condition to be created as an index and a transaction number, among data satisfying a predefined key or condition, to the blockchain index manager.

7. The apparatus of claim 5, wherein the data storage processing unit transfers a second index key, which is acquired by converting a first index key that is a target to be indexed using a user-specified function, to the blockchain index manager along with a transaction number corresponding thereto.

8. The apparatus of claim 3, wherein the query engine further includes a data search processing unit for acquiring a transaction number from the index using a predetermined key or condition through the blockchain index manager and acquiring data corresponding to the acquired transaction number through the blockchain connection manager in response to a request to retrieve the data corresponding to the predetermined key or condition.

9. A method for searching for on-chain data based on an index, comprising:
storing data resulting from occurrence of a transaction in at least one node of a blockchain network and creating an index for the stored data; and
retrieving data based on the index and outputting the data in response to a request to retrieve the data.

10. The method of claim 9, wherein the index includes at least one of an event index, a content-based index, a time-series index, a spatial index, or a key index, or a combination thereof.

11. The method of claim 9, further comprising:
before storing the data in the at least one node of the blockchain network,
defining a data schema corresponding to the data to be stored, setting a key or condition to be created as an index, and selecting an index structure depending on characteristics of the data to be stored.

12. The method of claim 11, wherein the index structure is selected from among structures including a binary tree, an R-tree, a k-dimensional (k-d) tree, a B-tree, and a B+ tree.

13. The method of claim 11, wherein creating the index includes
storing the data resulting from the occurrence of the transaction in the node of the blockchain network based on the defined data schema; and
recording a key or condition to be created as an index on the stored data and a transaction number in at least one corresponding index.

14. The method of claim 11, wherein creating the index comprises
when the index is constructed for already stored transactions, acquiring all data stored in at least one node of the blockchain network, checking column information corresponding to a key or condition to be created as an index in the acquired data, and inserting a key or condition to be created as an index and a transaction number, among data satisfying a predefined key or condition, into the index.

15. The method of claim 11, wherein creating the index comprises
inserting a second index key, which is acquired by converting a first index key that is a target to be indexed using a user-specified function, into the index along with a transaction number corresponding thereto.

16. The method of claim 11, wherein retrieving and outputting the data comprises acquiring a transaction number from the index using a predetermined key or condition and acquiring the data corresponding to the acquired transaction number from the blockchain network in response to a request to retrieve the data corresponding to the predetermined key or condition.

17. A method for searching for on-chain data based on an index, performed by a query engine interworking with a blockchain connection manager and a blockchain index manager,
the blockchain connection manager being connected with a blockchain network formed of multiple nodes connected with each other and being configured to record data in at least one node or retrieve data from at least one node and output the data and the blockchain index manager being configured to create and manage an index corresponding to data stored in at least one node of the blockchain network,
the method comprising:
defining a data schema corresponding to data to be stored before the data is stored in at least one node of the blockchain network, setting a key or condition to be created as an index, and selecting an index structure depending on characteristics of the data to be stored;
making a request to store data resulting from occurrence of a transaction in a corresponding node based on the defined data schema through the blockchain connection manager and recording a key or condition to be created as an index on the stored data and a transaction number in at least one corresponding index; and
acquiring a transaction number from the index using a predetermined key or condition through the blockchain index manager, acquiring data corresponding to the acquired transaction number through the blockchain connection manager, and outputting the data in response to a request to retrieve the data corresponding to the predetermined key or condition.

18. The method of claim 17, wherein:
the index includes at least one of an event index, a content-based index, a time-series index, a spatial index, or a key index, or a combination thereof, and
the index structure is selected from among structures including a binary tree, an R-tree, a k-dimensional (k-d) tree, a B-tree, and a B+ tree.

19. The method of claim 17, wherein recording the key or condition and the transaction number comprises,
when the index is constructed for already stored transactions, acquiring all data stored in at least one node of the blockchain network through the blockchain connection manager, checking column information corresponding to a key or condition to be created as an index in the acquired data, and transferring a key or condition to be created as an index and a transaction number, among data satisfying a predefined key or condition, to the blockchain index manager.

20. The method of claim 17, wherein recording the key or condition and the transaction number comprises transferring a second index key, which is acquired by converting a first index key that is a target to be indexed using a user-specified function, to the blockchain index manager along with a transaction number corresponding thereto.
